(19) United States
(12) Patent Application Publication
(10) Pub. No.: US 2004/0074543 A1
(43) Pub. Date: Apr. 22, 2004

(54) Valving and mixing unit

(76) Inventors: Robert Alan Dickson, Auckland (NZ); Mark Rodney Turner, Auckland (NZ); Graham Trevan Brain, Auckland (NZ)

Correspondence Address: JACOBSON HOLMAN PLLC, 400 SEVENTH STREET N.W., SUITE 600, WASHINGTON, DC, 20004, US

(21) Appl. No.: 10/415,342

(22) PCT Filed: Oct. 24, 2001
(86) PCT No.: PCT/NZ01/00235

(30) Foreign Application Priority Data
Nov. 2, 2000 (NZ) 507962
Jan. 22, 2001 (NZ) 509497

(51) Int. Cl. F16K 11/078

(52) U.S. Cl. 137/625.17

(57) ABSTRACT

For use in a shower installation, a mixer assembly with variable flow control insertable into a wall to have, when installed, a “front of wall” outlet for mixed water and a “front of wall” single control of both mix and flow to issue from said outlet, and an “in wall and/or back of wall” separate intake for hot and cold water. Preferably the assembly provides in use from the mixer assembly outlet a water flow via a flexible conduit to a shower head outlet. Such flow is controlled both as to water temperature and flow volume reliant upon single lever actuation of a rotor within the mixer assembly (preferably with a venturi draw in feature for that water feed of lesser pressure).

### TECHNICAL BACKGROUND

The present invention relates to flow control assemblies suitable for controlling the issuance of a mix of hot and cold water supplies to a shower head or to a “tap” outlet.

Systems exist whereby a flow control assembly controls the mix of cold and hot water supplies to be made available to an outlet such as might duct to a shower head or the outlet of a tap. Sometimes such assemblies if for a shower are at or adjacent the shower head itself. More usually such an assembly is positioned remotely therefrom.

### BACKGROUND ART

The present invention is applicable to either kind but preferably in respect of a shower, relates to one of a kind where a flexible hose or the like conduit provides a feed of the mixed water under control by a flow control assembly to the shower head.

In the past a variety, of different mix systems have been utilised where it has been possible with one control member (usually a lever handle) to control the flow volume as well as the hot and cold mix ratio. Such systems however have usually been reliant upon a ceramic cartridge such as that available from Galatron. Such cartridges are expensive. Moreover should there be a difficulty that requires correction, such correction usually requires the whole replacement of the expensive cartridge component.

The present invention is directed to an alternative to such a flow control assembly and one which preferably has a number advantages over such pre-existent systems for showers, taps, or the like.

The present invention for instance envisages that significant savings can arise in the installation of shower systems where ancillary componentry is kept to a minimum. For example, with most flow control assemblies (if not all) of the kind previously described, extensive plumbing behind the wall surface is required thus necessitating the use of additional lengths of conduit, elbows, etc.

The present invention preferably allows that largely to be avoided whilst at the same time providing preferably an assembly capable of ready repair should any componentry thereof suffer from wear.

It is therefore to such assemblies (whether for showers, taps or otherwise) and related uses, methods, components, etc. that the present invention is directed.

### DISCLOSURE OF THE INVENTION

In a first aspect the invention consists in a mixer assembly with variable fl w control installable into a wall to have, when installed, a “front of wall” outlet for mixed water and a “front of wall” single control of both mix and flow to issue from said outlet, and an “in wall and/or back of wall” separate intake for hot and cold water.

Preferably said outlet is an integral outlet of the body of the mixer assembly itself rather than of a coupled conduit outlet therefrom.

In another aspect the invention consists in a mixer assembly and face plate installation in and on a wall, said installation having,

in front of the wall, both an outlet for mixed water flow and a single control of both the mix and flow to issue from said outlet, and having, in and/or in back of the wall, both an intake for hot and an intake for cold water.

Preferably said outlet is of the mixer body of the mixer assembly itself and not of a coupled conduit outlet therefrom.

In yet another aspect the invention is a water outlet assembly of a shower which includes a behind wall separate feed of hot and cold water to a mixing unit, said mixing unit having a single control accessible in front of wall by the person being and/or to be showered to control both water temperature and flow volume to issue from the mixing unit, and a feed of any such mixed water to issue from said mixing unit via a flexible conduit to a shower head.

Preferably said mixing unit is mounted at or about waist height.

Preferably said hose connects downwardly from the unit from behind the control.

Preferably said control is in the form of a lever handle.

In even another aspect the invention is a mixer assembly with variable flow control installable into a wall to have, when installed, a “front of wall” outlet for mixed water and a “front of wall” single control of both mix and flow to issue from said outlet, and an “in wall and/or back of wall” separate intake for hot and cold water,

wherein the mixer assembly has a controllable flow volume and flow mix element movable in a mixer body, albeit with any necessary seals between the element and the mixer body, and the construction and arrangement of the element and the mixer body allows after the control movable element the higher pressure intake flow to elicit a venturi draw through of the lower pressure intake flow.

Preferably said element is not of a ceramic material.

In another aspect the invention consists in a flow control assembly for mounting at least partly into a wall to thereby define, in respect to the assembly, both a behind wall surface zone and an in front of wall surface zone, said assembly comprising or including

a housing having a separate hot water and cold water inlet positionable in use behind said wall surface and a mixed hot/cold water outlet positionable in use in front of said wall surface,

a rotatable and axially movable member (hereafter “rotor”) disposed at least in part within said housing to provide, depending on its disposition in said housing, an open, less open or closed flow path from each of said inlets to said outlet, and

control means whereby by manual input from in front of said wall surface said rotor can be moved selectively (i) rotatably, (ii) axially and (iii) both rotatably and axially to effect a control of both flow volume and mix ratio of hot and cold water to issue from said outlet.

It is therefore to such assemblies (whether for showers, taps or otherwise) and related uses, methods, components, etc. that the present invention is directed.

In another aspect the invention consists in a flow control assembly for mounting at least partly into a support to thereby define, in respect to the assembly, and/or below a behind support surface zone, said assembly comprising or including

a housing having a separate hot water and cold water inlet positionable in use below or behind said support surface and a mixed hot/cold water outlet positionable in use as a “tap” outlet or other outlet

a rotatable and axially movable member (hereafter “rotor”) disposed at least in part within said housing to provide, depending on its disposition in said housing, an open, less open or closed flow path from each of said inlets to said outlet, and

control means whereby by manual input from in above and/or front of said support surface said rotor can be moved selectively (i) rotatably, (ii) axially and (iii) both rotatably and axially to effect a control of both flow volume and mix ratio of hot and cold water to issue from said outlet.

In another aspect the present invention consists in a flow control assembly suitable for controlling the flow and/or mix of hot and cold water to a shower hose, (eg; as might duct mixed water to a shower head), said assembly being for mounting at least partly into a wall to thereby define a behind wall surface zone of the assembly and an in front of wall surface zone of the assembly, said assembly having

a housing having a separate hot water and cold water inlet positionable in use behind said wall surface and a mixed hot and cold water outlet positionable in use in front of said wall surface,

a rotatable and axially movable member (hereafter “rotor”) disposed at least in part within said housing to provide, depending on its disposition in said housing, the closure or some degree of opening of a flow path from each of said inlets to said outlet, and

control means whereby by manual input from in front of said wall surface in use said rotor can be moved selectively (i) rotatably, (ii) axially and (iii) both rotatably and axially to effect a control of both flow volume and mix ratio of the hot and cold water to issue from said outlet.

Preferably said rotor moves axially at least in part to control the overall volume of water to issue from said outlet.

Preferably said rotor moves rotatably to adjust the ratio of hot and cold water to issue from said outlet.

Preferably the hot and cold water mix within said rotor.

Preferably said control means includes a handle capable of being rotated about the rotation axis of said rotor and/or being pulled or pushed to adjust the axial position of said rotor at least in part within said housing.

Preferably the control means is connected to said rotor by a cam capable of controlling the axial position of said rotor at least in part within said housing.

Preferably said rotor and control means are such that said rotor is at least in part positioned within a bushing rotatable directly or indirectly by said handle, such bushing having a cam member pivoted with respect thereto transversely of the rotor axis, the rotation of said busing and the rotation and/or tilting of which cam member as allowed by its pivoted degree of freedom from said bushing is controllable by said handle thereby to achieve rotation and/or axial movement of said rotor.

Preferably said bushing entraps one end of said rotor such that rotational forces on said rotor are applied directly by said bushing and is not solely or at all reliant upon the cam/cam following interengagement between said bushing pivoted cam member and said cam following rotor.

Preferably the bushing and/or cam member and/or rotor cam following arrangement is substantially as hereinafter described with reference to any one or more of the accompanying drawings.

In another aspect the present invention consists in a flow control assembly suitable for controlling the flow and/or mix of hot and cold water to an outlet (e.g. to issue into a sink, tub, or the like), said assembly being for mounting at least partly from and/or into a support to thereby define a behind and/or below support surface zone of the assembly, said assembly having

a housing having a separate hot water and cold water inlet positionable in use behind and/or below said support surface and a mixed hot and cold water outlet positionable to issue the outlet water,

a rotatable and axially movable member (hereafter “rotor”) disposed at least in part within said housing to provide, depending on its disposition in said housing, the closure or some degree of opening of a flow path from each of said inlets to said outlet, and

control means whereby by manual input in use said rotor can be moved selectively (i) rotatably, (ii) axially and (iii) both rotatably and axially to effect a control of both flow volume and mix ratio of the hot and cold water to issue from said outlet.

Preferably said rotor moves axially at least in part to control the overall volume of water to issue from said outlet.

Preferably said rotor moves rotatably to adjust the ratio of hot and cold water to issue from said outlet.

Preferably the hot and cold water mix within said rotor.

Preferably said control means includes a handle capable of being rotated about the rotation axis of said rotor and/or being pulled or pushed to adjust the axial position of said rotor at least in part within said housing.

Preferably the control means is connected to said rotor by a cam capable of controlling the axial position of said rotor at least in part within said housing.

Preferably said rotor and control means are such that said rotor is at least in part positioned within a bushing rotatable directly or indirectly by said handle, such bushing having a cam member pivoted with respect thereto transversely of the rotor axis, the rotation of said busing and the rotation and/or tilting of which cam member as allowed by its pivoted degree of freedom from said bushing is controllable by said handle thereby to achieve rotation and/or axial movement of said rotor.

Preferably said bushing entraps one end of said rotor such that rotational forces on said rotor are applied directly by said bushing and is not solely or at all reliant upon the cam/cam following interengagement between said bushing pivoted cam member and said cam following rotor.

Preferably the bushing and/or cam member and/or rotor cam following arrangement is substantially as hereinafter described with reference to any one or more of the accompanying drawings.

In yet a further aspect the present invention consists in a rotor assembly suitable for inclusion in an assembly as previously defined.

Preferably said rotor assembly is substantially as hereinafter described with reference to any one or more of the accompanying drawings or is at least a product fabricated from a plurality of separate mouldings.

Preferably said rotor and said housing is such that said inlets are substantially diametrically opposed about the rotor axis and axial and/or rotational movement of the rotor provides for a varying degree of passage for water from a said inlet into said rotor and from thence to an outlet from said rotor in communication with said outlet of said housing.

In yet a further aspect the present invention consists in a rotor assembly suitable for inclusion in an assembly as previously defined.

Preferably said rotor assembly is substantially as hereinafter described with reference to any one or more of the accompanying drawings or is at least a product fabricated from a plurality of separate mouldings.

Preferably said rotor and said housing is such that said inlets are substantially diametrically opposed about the rotor axis and axial and/or rotational movement of the rotor provides for a varying degree of passage for water from a said inlet into said rotor and from thence to an outlet from said rotor in communication with said outlet of said housing.

In still a further aspect the invention is a rotor for or suitable for insertion in a housing of a water mixing assembly, said rotor being elongate in form and having two spaced lateral inlets to a mixing chamber and having axially spaced from said inlets a lateral outlet for water from said mixing chamber, there being porting from each of said inlets to said mixing chamber whereby one inlet flow to the mixing chamber can secure by reliance on a venturi effect a draw-in effect on the other flow in from the other inlet.

Preferably the elongate member has at one end thereof a cam follower or other member adapted to allow by dragging or pushing thereon (eg; by a cam or other member of a control member) some axial movement thereof and/or a rotation of said elongate rotor about a rotational axis thereof about which it is adapted to rotate in an appropriate housing.

Preferably said lateral outlet is to a surface of the rotor inset from a general longitudinal projection of the periphery of said rotor at said inlets.

In yet a further aspect the present invention consists in a rotor for or suitable for insertion in a housing of a water mixing assembly or parallel axes so as to be moveable rotatably about and/or axially along the same axis, said rotor having two spaced lateral inlets to a mixing chamber and have axially spaced from said inlets a lateral outlet or lateral outlets for water from said mixing chamber.

Preferably one of said inlets is into a sub-chamber which subsequently thereafter issues into said mixing chamber as it moves in a direction towards said outlet(s).

Preferably said rotor is an assembly of multiple components, at least one or more having been moulded (preferably of a plastics material).

Preferably said rotor is of a kind moulded to define a first part having said outlet and a passageway substantially along or parallel to the rotational axis of the rotor and a second component having said inlets, and optionally, a third component providing an end of said rotor away from the outlet end of the rotor.

Preferably said components are joined by a welding, melding or the like procedure, eg; spin-welding, sonic-welding.

Preferably said rotor has at least one part or component thereof made from an acetal resin.

In still a further aspect the present invention consists in a rotor for or suitable for insertion in a housing of a water mixing assembly, said rotor having two lateral inlets each to receive a separate feed of water in use and axially spaced from such inlets at least one (preferably lateral) outlet, the rotor being such that water entering one or both of said inlets can move to said outlet,

wherein said rotor is to be movable in an appropriate housing both rotationally and rectilinearly along the same axis or parallel axes,

and wherein with respect to the said axis or axes, that end of said rotor closest to said outlet is provided with means adapted to engage directly or indirectly a control member (for example, a mixing lever, eg; via a cam) so as to be moveable rectilinearly and/or rotationally.

Preferably said outlet is at a zone adapted to provide in an appropriate chamber an annular chamber from whence the water can then flow to an outlet of said housing.

In still another aspect the invention is, in combination, a rotor as previously defined and an appropriate housing therefor, said housing being adapted to allow an out-feed of water from said outlet of said rotor on the “in front of wall” side of an in use fitted shower system.

In still another aspect the invention is, in combination, a rotor as previously defined and an appropriate housing therefor, said housing being adapted to allow an out-feed of water from said outlet of said rotor of a thus controlled “tap”, faucet, or the like outlet.

In another aspect the present invention consists in a rotor substantially as hereinafter described with reference to any one or more of the accompanying drawings.

In still a further aspect the present invention consists, as a kit, a rotor substantially as hereinbefore described and/or as shown in any one or more of the accompanying drawings and, a bushing substantially as hereinbefore described and/or as herein described with reference to any one or more of the accompanying drawings and a cam member as hereinbefore defined and/or substantially as herein described with reference to any one or more of the accompanying drawings.

In yet a further aspect the present invention consists in a shower mixing unit adapted to provide a feed of water controlled as to hot/cold mixing and total flow via an outlet in front of the wall or shower liner, said unit comprising or including a rotor, a housing and a control member, the control of both the mix and the flow being under the action of a rotor member having two inlets and at least one outlet, said rotor being both rectangularly moveable as well as rotatable about the same axis or parallel axes within a housing so as to control the infeed of water in via each of said inlets both as to individual inflows and relativity of such inflows and to mix the same either within or exteriorly (or both) of said rotor for issuance from an outlet of the housing, said rotor being controllable directly or indirectly by a single control member (such as a handle, lever or the like).

Preferably said single control member acts via a cam/cam-follower and/or articulating mechanism between said control member and said rotor.

In yet a further aspect the present invention consists in a mixing unit adapted to provide a feed of water controlled as to hot/cold mixing and total flow via an outlet (e.g. as if a tap, faucet or the like), said unit comprising or including a rotor, a housing and a control member, the control of both the mix and the flow being under the action of a rotor member having two inlets and at least one outlet, said rotor being both rectilinearly moveable as well as rotatable about the same axis or parallel axes within a housing so as to control the infeed of water in via each of said inlets both as to individual inflows and relativity of such inflows and to mix the same either within or exteriorly (or both) of said rotor for issuance from an outlet of the housing, said rotor being controllable directly or indirectly by a single control member (such as a handle, lever or the like).

Preferably said single control member acts via a cam/cam-follower and/or articulating mechanism between said control member and said rotor.

In still a further aspect the present invention consists in a water outlet assembly of a shower which includes a behind wall feed of hot and cold water to a (preferably waist) level mixing unit, said mixing unit having a single control accessible by the person being and/or to be showered to control both temperature and flow volume, and a feed from the unit of which said control forms part via a flexible conduit to a shower head.

Preferably said arrangement incorporate apparatus in accordance with the present invention.

Preferably said hose connects downwardly from the unit from behind the control which preferably is in the form of a lever or the like handle.

### DETAILED DESCRIPTION OF THE INVENTION

Preferred forms of the present invention will now be described with reference to the shower usages with reference to the accompanying drawings in which;

FIG. 1 shows a diagrammatic view (from the view point of a user) of a conventional prior art mixer unit where the mixing of the water is to take place at or about waist height yet the shower rose (connectable by a flexible hose or other conduit) is to be held by known means at or about head height, such a mixer having behind the shower liner and set back into the wall the infeed of a separate hot and cold water feed and the behind the shower liner or set back into the wall an outlet from the mixer through to an outlet unit set back into the wall which then protrudes out from the wall into the shower cubicle or the equivalent thereafter to connect via said hose the shower head, the components A, B and C being behind the wall, the control lever D (which for example acts through a GALATRON™ type cartridge) controlling the mix of the hot and cold feeds A and B respectively to pass through conduit C from the mixer and then to come out through the wall via the outlet E and from thence via the hose F to the shower head G,

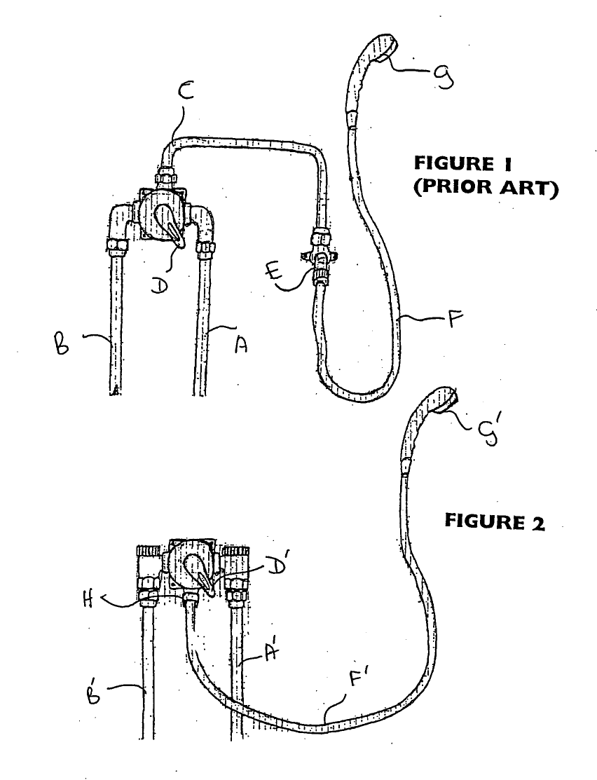

FIG. 2 is a similar view to that of FIG. 2 but this time showing where a waist height control level D′ controls (the behind shower liner and in wall) hot and cold feed A′ and B′ respectively to an outlet H which is in front of the wall from thence (via the hose F′) to a shower head G, the arrangement of the present invention avoiding the need for fittings such as C and E,

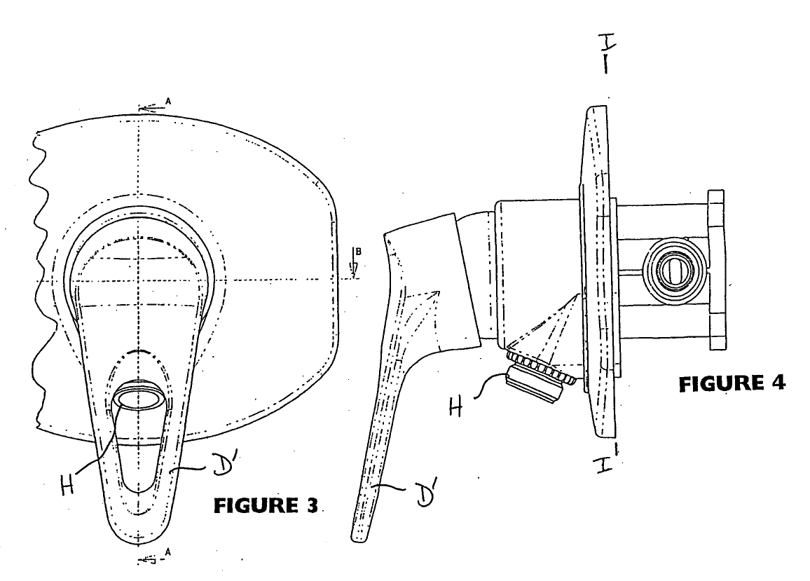

FIG. 3 shows a front view from the in shower direction of a single control handle D′ in accordance with the present invention which preferably is adapted to overlie an outlet such as H as depicted in FIG. 2,

FIG. 4 is a side elevation view of a unit as depicted in FIG. 3, that region to the right of the line I-I in accordance with the invention as defined herein being in the “behind wall surface zone” and that region to the left of the line I-I being in the “in front of said wall surface zone”,

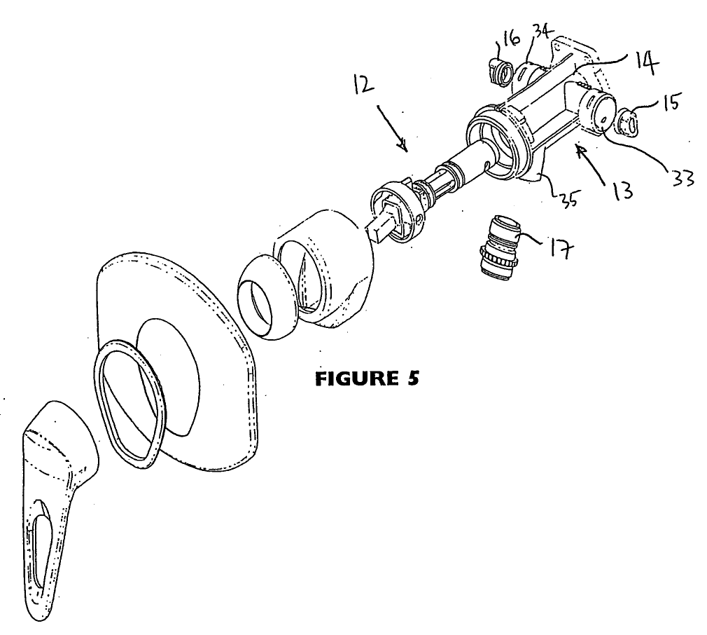

FIG. 5 is an exploded view of the arrangement shown in FIGS. 3 and 4,

FIG. 6 is an exploded view of the components (which could be sold as a kit) which constitutes the rotor, the cam member and the bushing as aforesaid, such an arrangement being also shown in its assembled form in the exploded view FIG. 5,

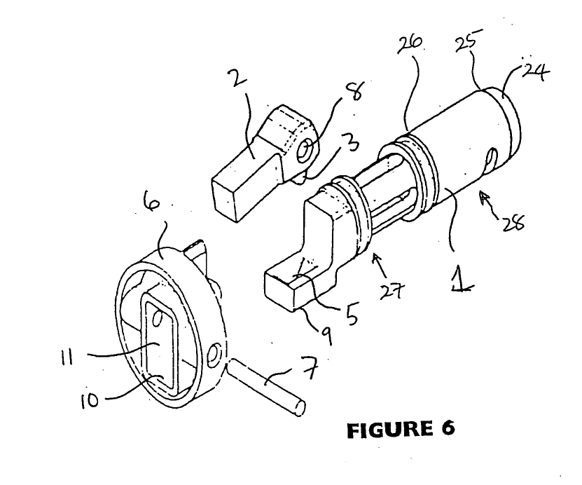

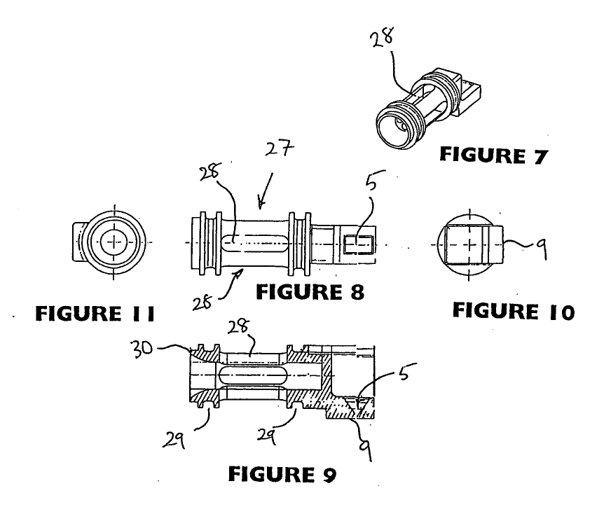

FIG. 7 shows a moulding which forms part of the rotor depicted in FIG. 6 being adapted to be associated with two other moulded components to provide the rotor as shown in FIG. 6, such association being by spin and/or ultrasonic welding,

FIG. 8 is a top view of the moulded component of FIG. 7,

FIG. 9 is a cross sectional elevational view of the component as shown in FIG. 7 showing the cam following depression into which part of the cam member is to engage,

FIG. 10 is a view from the right hand end of the component of FIG. 8,

FIG. 11 is a view from the left hand end of the component of FIG. 11,

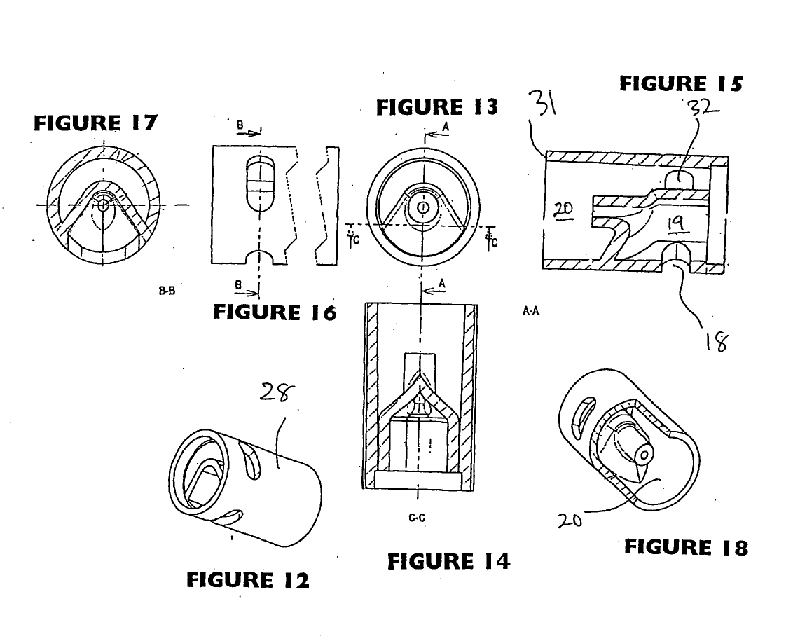

FIG. 12 is a separate moulding to that component of FIGS. 7 through 11 but which nonetheless is to be welded thereto to form (in conjunction with an end cap) the rotor of FIGS. 5 and 6, FIG. 12 showing the moulded component with its inlet openings one into a chamber which will by virtue of an outlet provide a venturi effect on the flow in from the other or vice versa,

FIG. 13 is an end view of the component shown in FIG. 12,

FIG. 14 is a section at C-C of the component of FIG. 13,

FIG. 15 is a section at A-A of the component of FIGS. 13 and 14,

FIG. 16 is a side elevation view of part of the component of FIG. 12 showing the relationship of the inlets,

FIG. 17 is a section at B-B in the direction arrow,

FIG. 18 is a reverse perspective view of the component of FIG. 12 partly cutaway,

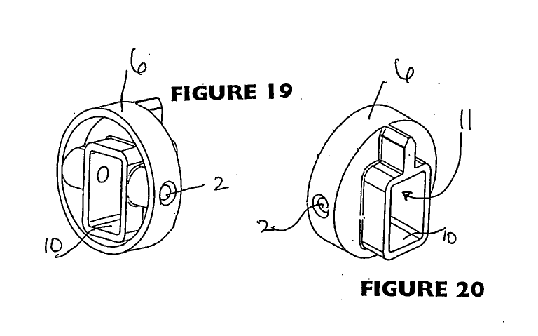

FIG. 19 is a perspective view from one direction of a component of the cap shown in FIG. 6,

FIG. 20 is a reverse view of that moulded component (the bushing) from the other direction,

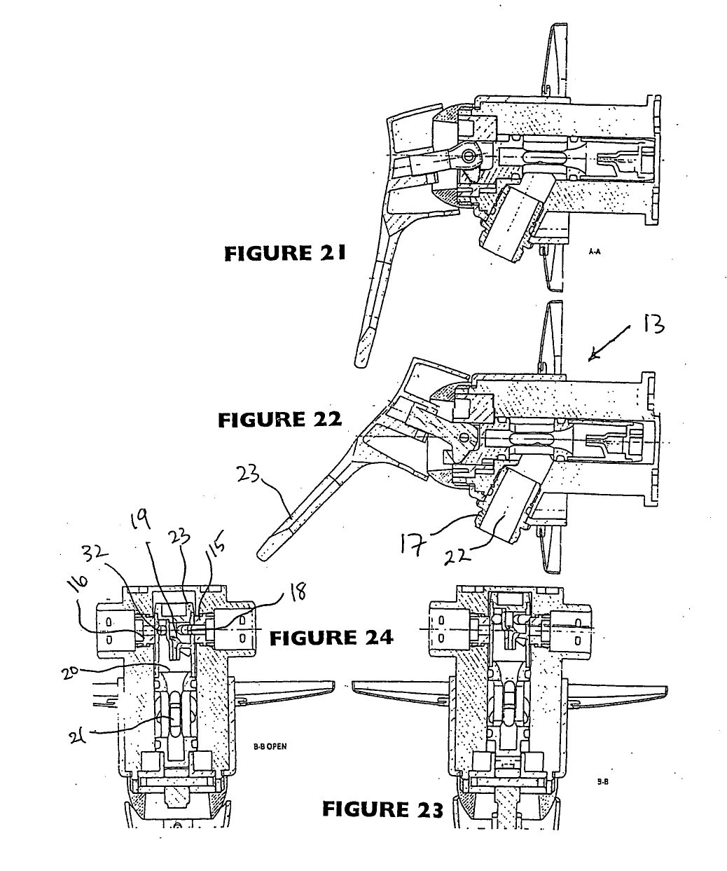

FIG. 21 is a side elevational view in section of the assembly in accordance with the present invention, such section being at A-A with respect to FIG. 3, the control lever being such as to have the rotor in its most fully “to the right” condition which equates to no flow,

FIG. 22 is a similar view to that of FIG. 21 but showing the control member through its association with the cam member and the rotor via the bushing as having been capable of moving the rotor to its fully “to the left” condition which equates to an open condition for the flow or flows (the proportion of the infeed from A′ or B′ being determined by the rotational condition of the control lever),

FIG. 23 is a section at B-B with respect to FIG. 3 of the arrangement as depicted in FIG. 21,

FIG. 24 is a cross sectional view at B-B as shown in FIG. 3 when in the open condition as depicted in FIG. 22,

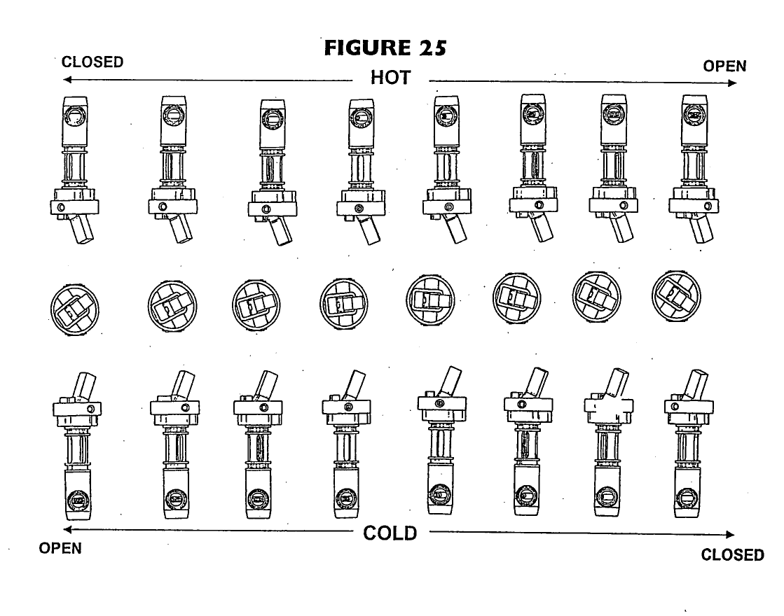

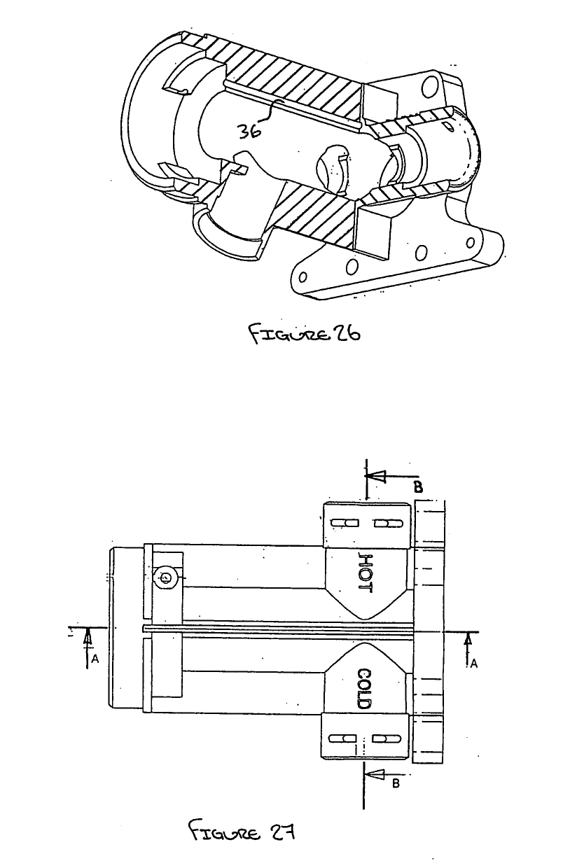

FIG. 25 shows the rotor bushing cam member arrangement (in conjunction with the seals shown in FIG. 5) whereby, for the top sequence which is representative of (eg;) the hot water infeed via, for example, conduit A′ there is a closed hot water infeed into the rotor on the left and a fully open infeed on the right, the degree of infeed in between being determined (as can be seen) by the degree of exposure of the inlet port into the rotor to the water infeed, the lower most sequence showing the opposite condition (eg;) for the cold water infeed, and the middle sequence showing the control handle end of the assembly when viewed axially of the rotational axis to better demonstrate the angular condition of the cam member and the bushing for the corresponding top and bottom sequences,

FIG. 26 is a perspective view from below in partial section of a housing of a different form to that previously defined which includes machined or moulded therein (eg; if of a plastics material) a bleed conduit to allow pressure equalisation,

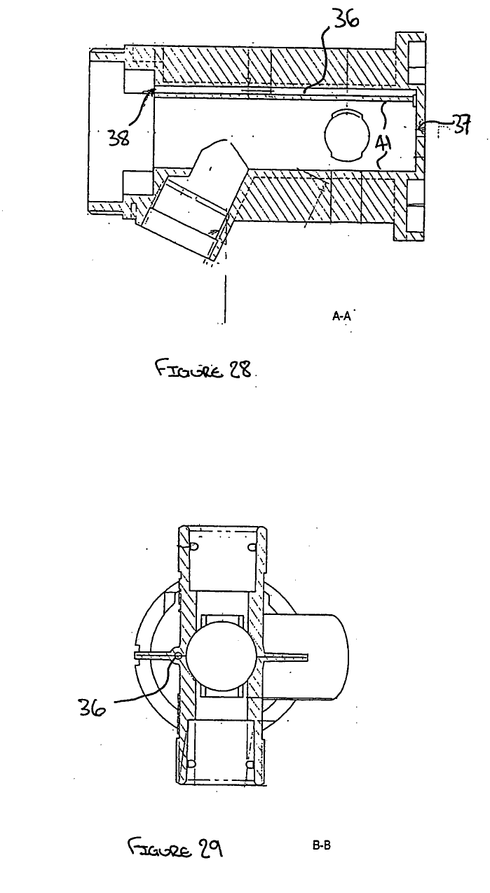

FIG. 27 is a plan view of the housing of FIG. 26,

FIG. 28 is a sectional view of the housing of FIG. 26 in the direction “AA” depicted on FIG. 27,

FIG. 29 is a sectional view “BB” as shown in FIG. 27,

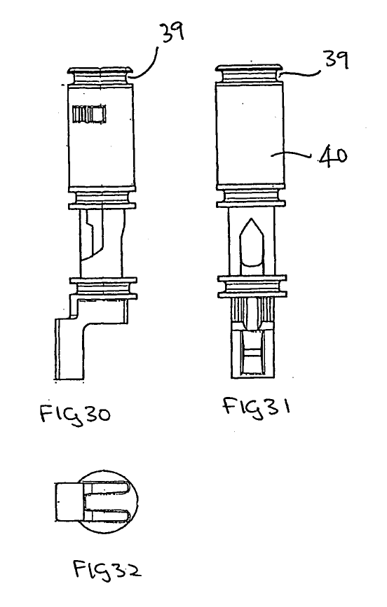

FIG. 30 shows a view of a different rotatable and axially movable member to that previously defined as the “rotor”, this embodiment allowing three O-ring seals to be utilised,

FIG. 31 is a similar view to that of FIG. 30 but showing the rotor rotated by 90°, and

FIG. 32 is an end view of the arrangement of FIG. 30.

Persons skilled in the plumbing art can visualise the outlet being that of a mixing tap of a basin, tub or the like in which case the bench or other support assumes (preferably) the role the wall does in the shower mixer application.

In the preferred form of the present invention the arrangement is operable in a manner as depicted in FIG. 2 as described previously. Appropriate wall support(s) for the shower head can be provided.

The present invention allows both a temperature and flow control at or about waist height in a unit whereby the outlet from the mixing/flow control unit is in front of the wall thus obviating the plumbing components such as “C” and “E” described with respect to FIG. 1. Moreover, in providing such an arrangement the use of expensive cartridges of the GALATRON™ type can preferably be avoided because of reliance inter alia on the component 1 (see FIG. 6) which is the rotor and which is axially movable and rotatable under the action of the cam member 2, the nose 3 of which engages into the recess or cam follower 5 of the rotor.

A bushing 6 is provided and that receives a pin 7 adapted to pass through the opening 8 of the cam member 2 even whilst the lower surface 9 of the rotor rests on the bottom surface 10 of the passageway 11 through the bushing 6.

The assembled components of FIG. 6 can be seen in (inter alia) FIG. 5 as subassembly 12. The component 27 with its outlets 28 for the water flow from the mixing chamber and its grooves 29 to locate O-rings is preferably spin welded at its end 30 to the end 31 of the moulded component 28 which includes the inlets 18 and 32. A separately formed cap member 24 is ultrasonically welded to the other end of the component 28 at 25, the aforementioned spin welding being at 26 (see FIG. 6).

The housing is as depicted in the exploded view of FIG. 5 as 13, the housing being a moulded component 14 adapted to receive seal members 15 and 16 to bear with captured O-ring onto the cylindrical surface of that part of the rotor having the inlets (see FIGS. 12 to 18) the housing is also adapted to receive an outlet connector 17 for the hose F′ shown in FIG. 2. A better appreciation of the form of the housing 13 can be derived by reference to FIGS. 12 through 15.

The housing assembly depicted in FIG. 5 includes integrally moulded therein parts 33, 34 each adapted to connect a conduit such as A′ and B′ as well as an outlet 35 adapted to receive the component 17. The entrance ways 33 and 34 are adapted to have located therein as previously mentioned the seal members 15 and 16 respectively as shown in the sectional views of FIGS. 21 through 24.

As can be seen the rotor 1 is axially movable between the closed condition of FIG. 12 and the open condition of FIG. 13. FIG. 15 by way of example shows an infeed via housing hot water inlet 18 via a sub-chamber 19 and from thence into the mixing chamber prop-up 20 and from thence out of the outlets 21 and from thence out of the outlet 22 provided by the member 17 to which the hose F′ is attached.

The degree of opening of the hot or cold intakes or indeed the full closure thereof is controllable by the degree of rotation and pulling outwardly or pushing inwardly of the control lever 23.

The arrangement of the control between the conditions of fully open and fully closed for the hot water and the respective fully closed and fully open condition of the cold water can best be appreciated by reference to FIG. 16.

Moulded forms of the housing and rotor are shown in FIGS. 26 through 32. These forms which lend themselves to moulding from an appropriate plastics material can alternatively if desired be machined from an appropriate material whether a plastics material or a metal. Any material traditionally utilised for such members can be employed.

Where the arrangement of FIGS. 27 onwards differs from that previously defined is in the provision of a moulded or machined venting conduit 36 capable of coacting in such a way as to allow venting of any fluids between the rotor and the end 37 of the housing back out to the region shown as 38. This venting of fluids (primarily air) will remove any sponginess caused by compression of gas behind the O-ring that preferably is about the annular groove 39 of the rotor 40 and the cylindrical surface 41 of the housing. The provision of an additional O-ring about 39 has the ability to further reduce leakage about the rotor within the barrel 41 which may adversely effect control and may lead to unwanted dripping of waters via the outlet and/or unwanted merging of hot with cold.

A person skilled in the art will appreciate the appropriate seals and other means of interengagement and assembly required for the arrangement shown in the accompanying drawings and where if appropriate, appropriate elastomer or the like O-rings, etc. are associated with components in order to restrict the flows so that either there is no flow or there is a flow with the volume of the flow being controlled by the axial disposition of the rotor in the housing and the relativity of hot to cold water being dependent upon the rotational disposition of the lever 23. Other factors relevant to the hot and cold water flow will depend upon the relative infeed pressure of each and which is chosen to first pass through the chamber 19 when the unit is being fitted by a plumber. Thereafter one flow will exert a venturi effect on the other allowing the higher pressure flow to have a draw in effect on the lesser flow.

Persons skilled in the art will appreciate the savings that can arise from the use of the present invention in a shower application. Person will also see from the foregoing and the drawings how the outlet 22 can be a tap outlet whilst the wall is a bench, wall or the like in a tap, faucet or the like application.

1. A mixer assembly with variable flow control installable into a wall to have, when installed, a “front of wall” outlet for mixed water and a “front of wall” single control of both mix and flow to issue from said outlet, and an “in wall and/or back of wall” separate intake for hot and cold water.

2. A mixer assembly of claim 1 wherein said outlet is an integral outlet of the body of the mixer assembly itself rather than of a coupled conduit outlet therefrom.

3. A mixer assembly and face plate installation in and on a wall, said installation having, in front of the wall, both an outlet for mixed water flow and a single control of both the mix and flow to issue from said outlet, and having, in and/or in back of the wall, both an intake for hot and an intake for cold water.

4. An installation of claim 3 wherein said outlet is of the mixer body of the mixer assembly itself and not of a coupled conduit outlet therefrom.

5. A water outlet assembly of a shower which includes a behind wall separate feed of hot and cold water to a mixing unit, said mixing unit having a single control accessible in front of wall by the person being and/or to be showered to control both water temperature and flow volume to issue from the mixing unit via a flexible conduit to a shower head outlet.

6. An assembly of claim 5 wherein said mixing unit is mounted at or about waist height.

7. An assembly of claim 5 or 6 wherein said hose connects downwardly from the unit from behind the control.

8. An assembly of claim 6 or 7 wherein said control is in the form of a lever handle.

9. A mixer assembly with variable flow control installable into a wall to have, when installed, a “front of wall” outlet for mixed water and a “front of wall” single control of both mix and flow to issue from said outlet, and an “in wall and/or back of wall” separate intake for hot and cold water,
wherein the mixer assembly has a controllable flow volume and flow mix element movable in a mixer body, albeit with any necessary seals between the element and the mixer body, and the construction and arrangement of the element and the mixer body allows after the control movable element the higher pressure intake flow to elicit a venturi draw through of the lower pressure intake flow.

10. An assembly of claim 9 wherein said element is not of a ceramic material.

11. A flow control assembly for mounting at least partly into a wall to thereby define, in respect to the assembly, both a behind wall surface zone and an in front of wall surface zone, said assembly comprising or including
a housing having a separate hot water and cold water inlet positionable in use behind said wall surface and a mixed hot/cold water outlet positionable in use in front of said wall surface,
a rotatable and axially movable member (hereafter “rotor”) disposed at least in part within said housing to provide, depending on its disposition in said housing, an open, less open or closed flow path from each of said inlets to said outlet, and
control means whereby by manual input from in front of said wall surface said rotor can be moved selectively (i) rotatably, (ii) axially and (iii) both rotatably and axially to effect a control of both flow volume and mix ratio of hot and cold water to issue from said outlet.

12. A flow control assembly of claim 11 wherein said rotor moves axially at least in part to control the overall volume of water to issue from said outlet.

13. A flow control assembly of claims 11 or 12 wherein said rotor moves rotatably to adjust the ratio of hot and cold water to issue from said outlet.

14. A flow control assembly of claim 11 to 13 wherein the hot and cold water mix within said rotor.

15. A flow control assembly of claim 11 to 14 wherein said control means includes a handle capable of being rotated about the rotation axis of said rotor and/or being pulled or pushed to adjust the axial position of said rotor at least in part within said housing.

16. A flow control assembly of claim 11 to 15 wherein the control means is connected to said rotor by a cam capable of controlling the axial position of said rotor at least in part within said housing.

17. A flow control assembly of claim 11 to 16 wherein said rotor and control means are such that said rotor is at least in part positioned within a bushing rotatable directly or indirectly by said handle, such bushing having a cam member pivoted with respect thereto transversely of the rotor axis, the rotation of said busing and the rotation and/or tilting of which cam member as allowed by its pivoted degree of freedom from said bushing is controllable by said handle thereby to achieve rotation and/or axial movement of said rotor.

18. A flow control assembly of claim 17 wherein said bushing entraps one end of said rotor such that rotational forces on said rotor are applied directly by said bushing and is not solely or at all reliant upon the cam/cam following interengagement between said bushing pivoted cam member and said cam following rotor.

19. A flow control assembly of claim 17 or 18 wherein the bushing and/or cam member and/or rotor cam following arrangement is substantially as herein described with reference to any one or more of the accompanying drawings.

20. A flow control assembly for mounting at least partly into a support to thereby define, in respect to the assembly, and/or below a behind support surface zone, said assembly comprising or including
a housing having a separate hot water and cold water inlet positionable in use below or behind said support surface and a mixed hot/cold water outlet positionable in use as a “tap” outlet or other outlet
a rotatable and axially movable member (hereafter “rotor”) disposed at least in part within said housing to provide, depending on its disposition in said housing, an open, less open or closed flow path from each of said inlets to said outlet, and
control means whereby by manual input from in above and/or front of said support surface said rotor can be moved selectively (i) rotatably, (ii) axially and (iii) both rotatably and axially to effect a control of both flow volume and mix ratio of hot and cold water to issue from said outlet.

21. A flow control assembly of claim 20 wherein said rotor moves axially at least in part to control the overall volume of water to issue from said outlet.

22. A flow control assembly of claim 20 or 21 wherein said rotor moves rotatably to adjust the ratio of hot and cold water to issue from said outlet.

23. A flow control assembly of claim 20 to 22 wherein the hot and cold water mix within said rotor.

24. A flow control assembly of claim 20 to 23 wherein said control means includes a handle capable of being rotated about the rotation axis of said rotor and/or being pulled or pushed to adjust the axial position of said rotor at least in part within said housing.

25. A flow control assembly of claim 20 to 24 wherein the control means is connected to said rotor by a cam capable of controlling the axial position of said rotor at least in part within said housing.

26. A flow control assembly of claim 20 to 25 wherein said rotor and control means are such that said rotor is at least in part positioned within a bushing rotatable directly or indirectly by said handle, such bushing having a cam member pivoted with respect thereto transversely of the rotor axis, the rotation of said busing and the rotation and/or tilting of which cam member as allowed by its pivoted degree of freedom from said bushing is controllable by said handle thereby to achieve rotation and/or axial movement of said rotor.

27. A flow control assembly of claim 26 wherein said bushing entraps one end of said rotor such that rotational forces on said rotor are applied directly by said bushing and is not solely or at all reliant upon the cam/cam following interengagement between said bushing pivoted cam member and said cam following rotor.

28. A flow control assembly of claim 26 or 27 wherein the bushing and/or cam member and/or rotor cam following arrangement is substantially as herein described with reference to any one or more of the accompanying drawings.

29. A flow control assembly suitable for controlling the flow and/or mix of hot and cold water to a shower hose, said assembly being for mounting at least partly into a wall to thereby define a behind wall surface zone of the assembly and an in front of wall surface zone of the assembly, said assembly having
a housing having a separate hot water and cold water inlet positionable in use behind said wall surface and a mixed hot and cold water outlet positionable in use in front of said wall surface,
a rotatable and axially movable member (hereafter “rotor”) disposed at least in part within said housing to provide, depending on its disposition in said housing, the closure or some degree of opening of a flow path from each of said inlets to said outlet, and
control means whereby by manual input from in front of said wall surface in use said rotor can be moved selectively (i) rotatably, (ii) axially and (iii) both rotatably and axially to effect a control of both flow volume and mix ratio of the hot and cold water to issue from said outlet.

30. An assembly of claim 29 wherein said hose ducts in use ;mixed water to a shower head.

31. A flow control assembly of claim 29 to 30 wherein said rotor moves axially at least in part to control the overall volume of water to issue from said outlet.

32. A flow control assembly of claim 29 to 31 wherein said rotor moves rotatably to adjust the ratio of hot and cold water to issue from said outlet.

33. A flow control assembly of claim 29 to 32 wherein the hot and cold water mix within said rotor.

34. A flow control assembly of claim 29 to 33 wherein said control means includes a handle capable of being rotated about the rotation axis of said rotor and/or being pulled or pushed to adjust the axial position of said rotor at least in part within said housing.

35. A flow control assembly of claim 29 to 34 wherein the control means is connected to said rotor by a cam capable of controlling the axial position of said rotor at least in part within said housing.

36. A flow control assembly of claim 35 wherein said rotor and control means are such that said rotor is at least in part positioned within a bushing rotatable directly or indirectly by said handle, such bushing having a cam member pivoted with respect thereto transversely of the rotor axis, the rotation of said busing and the rotation and/or tilting of which cam member as allowed by its pivoted degree of freedom from said bushing is controllable by said handle thereby to achieve rotation and/or axial movement of said rotor.

37. A flow control assembly of claim 36 wherein said bushing entraps one end of said rotor such that rotational forces on said rotor are applied directly by said bushing and is not solely or at all reliant upon the cam/cam following interengagement between said bushing pivoted cam member and said cam following rotor.

38. A flow control assembly of claim 33 or 37 wherein the bushing and/or cam member and/or rotor cam following arrangement is substantially as herein described with reference to any one or more of the accompanying drawings.

39. A flow control assembly suitable for controlling the flow and/or mix of hot and cold water to an outlet, said assembly being for mounting at least partly from and/or into a support to thereby define a behind and/or below support surface zone of the assembly, said assembly having
a housing having a separate hot water and cold water inlet positionable in use behind and/or below said support surface and a mixed hot and cold water outlet positionable to issue the outlet water,
a rotatable and axially movable member (hereafter “rotor”) disposed at least in part within said housing to provide, depending on its disposition in said housing, the closure or some degree of opening of a flow path from each of said inlets to said outlet, and
control means whereby by manual input in use said rotor can be moved selectively (i) rotatably, (ii) axially and (iii) both rotatably and axially to effect a control of both flow volume and mix ratio of the hot and cold water to issue from said outlet.

40. A flow control assembly of claim 39 said rotor moves axially at least in part to control the overall volume of water to issue from said outlet.

41. An assembly of claim 39 wherein said outlet is to a sink, tub or bath.

42. A flow control assembly of claim 39 to 41 wherein said rotor moves rotatably to adjust the ratio of hot and cold water to issue from said outlet.

43. A flow control assembly of claim 39 to 42 wherein the hot and cold water mix within said rotor.

44. A flow control assembly of claim 39 to 43 wherein said control means includes a handle capable of being rotated about the rotation axis of said rotor and/or being pulled or pushed to adjust the axial position of said rotor at least in part within said housing.

45. A flow control assembly of claim 39 to 44 wherein the control means is connected to said rotor by a cam capable of controlling the axial position of said rotor at least in part within said housing.

46. A flow control assembly of claim 45 wherein said rotor and control means are such that said rotor is at least in part positioned within a bushing rotatable directly or indirectly by said handle, such bushing having a cam member pivoted with respect thereto transversely of the rotor axis, the rotation of said busing and the rotation and/or tilting of which cam member as allowed by its pivoted degree of freedom from said bushing is controllable by said handle thereby to achieve rotation and/or axial movement of said rotor.

47. A flow control assembly of claim 46 wherein said bushing entraps one end of said rotor such that rotational forces on said rotor are applied directly by said bushing and is not solely or at all reliant upon the cam/cam following interengagement between said bushing pivoted cam member and said cam following rotor.

48. A flow control assembly of claim 47 wherein the bushing and/or cam member and/or rotor cam following arrangement is substantially as herein described with reference to any one or more of the accompanying drawings.

49. An assembly of any one of claims 39 to 48 said rotor and said housing is such that said inlets are substantially diametrically opposed about the rotor axis and axial and/or rotational movement of the rotor provides for a varying degree of passage for water from a said inlet into said rotor and from thence to an outlet from said rotor in communication with said outlet of said housing.

50. A flow control assembly of claim 49 wherein said rotor and said housing is such that said inlets are substantially diametrically opposed about the rotor axis and axial and/or rotational movement of the rotor provides for a varying degree of passage for water from a said inlet into said rotor and from thence to an outlet from said rotor in communication with said outlet of said housing.

51. A rotor for or suitable for insertion in a housing of a water mixing assembly, said rotor being elongate in form and having two spaced lateral inlets to a mixing chamber and having axially spaced from said inlets a lateral outlet for water from said mixing chamber, there being porting from each of said inlets to said mixing chamber whereby one inlet flow to the mixing chamber can secure by reliance on a venturi effect a draw-in effect on the other flow in from the other inlet.

52. A rotor for or suitable for insertion in a housing of a water mixing assembly of claim 51 wherein the elongate member has at one end thereof a cam follower or other member adapted to allow by dragging or pushing thereon by a cam or other member of a control member some axial movement thereof and/or a rotation of said elongate rotor about a rotational axis thereof about which it is adapted to rotate in an appropriate housing.

53. A rotor for or suitable for insertion in a housing of a water mixing assembly of claim 51 or 52 wherein said lateral outlet is to a surface of the rotor inset from a general longitudinal projection of the periphery of said rotor at said inlets.

54. A rotor for or suitable for inserti n in a housing of a water mixing assembly so as to be moveable rotatably about and/or axially along the same axis, said rotor having two spaced lateral inlets to a mixing chamber and have axially spaced from said inlets a lateral outlet or lateral outlets for water from said mixing chamber.

55. A rotor for or suitable for insertion in a housing of a water mixing assembly of claim 54 wherein one of said inlets is into a sub-chamber which subsequently thereafter issues into said mixing chamber as it moves in a direction towards said outlet(s).

56. A rotor for or suitable for insertion in a housing of a water mixing assembly of claim 54 or 55 wherein said rotor is an assembly of multiple components, at least one or more having been moulded (preferably of a plastics material).

57. A rotor for or suitable for insertion in a housing of a water mixing assembly of any one of claims 54 to 56 being of a kind moulded to define with separate mouldings, a first part having said outlet and a passageway substantially along or parallel to the rotational axis of the rotor and a second component having said inlets, and optionally, a third part providing an end of said rotor away from the outlet end of the rotor.

58. A rotor for or suitable for insertion in a housing of a water mixing assembly of claim 57 wherein said parts are joined by a welding, melding or the like procedure, eg; spin-welding, sonic-welding.

59. A rotor for or suitable for insertion in a housing of a water mixing assembly of claim 57 or 58 wherein said rotor has at least one part or component thereof made from an acetal resin.

60. A rotor for or suitable for insertion in a housing of a water mixing assembly, said rotor having two lateral inlets each to receive a separate feed of water in use and axially spaced from such inlets at least one outlet, the rotor being such that water entering one or both of said inlets can move to said outlet,
wherein said rotor is to be movable in an appropriate housing both rotationally and rectilinearly along the same axis or parallel axes,
and wherein with respect to the said axis or axes, that end of said rotor closest to said outlet is provided with means adapted to engage directly or indirectly a control member (for example, a mixing lever, eg; via a cam) so as to be moveable rectilinearly and/or rotationally.

61. A rotor of claim 60 wherein said outlet(s) is(are) are laterally of the rotor at a zone adapted to provide in an appropriate chamber an annular chamber from whence the water can then flow to an outlet of said housing.

62. A rotor substantially as herein described with reference to any one or more of the accompanying drawings.

63. In combination, a rotor as defined in any one of claims 51 to 62 and an appropriate housing therefor forming or to form part of a shower water mixing system, said housing being adapted to allow an out-feed of water from said outlet(s) of said rotor to the “in front of wall” side of said shower water mixing system in use.

64. In combination, a rotor as defined in any one of claims 51 to 62 and an appropriate housing therefor, said housing being adapted to allow an out-feed of water from said outlet of said rotor of a thus controlled tap, faucet, or the like outlet.

65. A kit, comprising or including a rotor of any one of claims 51 to 62, a bushing and a cam member, such components of the kit being of a kind for inclusion in an assembly of any one of claims 1 to 53.

66. A shower mixing unit adapted to provide a feed of water controlled as to hot/cold mixing and total flow via an outlet in front of the wall or shower liner, said unit comprising or including a rotor, a housing and a control member, the control of both the mix and the flow being under the action of a rotor member having two inlets and at least one outlet, said rotor being both rectangularly moveable as well as rotatable about the same axis or parallel axes within a housing so as to control the infeed of water in via each of said inlets both as to individual inflows and relativity of such inflows and to mix the same either within or exteriorly (or both) of said rotor for issuance from an outlet of the housing, said rotor being controllable directly or indirectly by a single control member.

67. A unit of claim 66 wherein said single control member acts via a cam/cam-follower and/or articulating mechanism between said control member and said rotor.

68. A mixing unit adapted to provide a feed of water controlled as to hot/cold mixing and total flow via an outlet (e.g. as if a tap, faucet or the like), said unit comprising or including a rotor, a housing and a control member, the control of both the mix and the flow being under the action of a rotor member having two inlets and at least one outlet, said rotor being both rectilinearly moveable as well as rotatable about the same axis or parallel axes within a housing so as to control the infeed of water in via each of said inlets both as to individual inflows and relativity of such inflows and to mix the same either within or exteriorly (or both) of said rotor for issuance from an outlet of the housing, said rotor being controllable directly or indirectly by a single human actuable control member.

69. A unit of claim 68 wherein said single control member acts via a cam/cam-follower and/or articulating mechanism between said control member and said rotor.
